(19) United States
(12) Patent Application Publication
(10) Pub. No.: US 2003/0233299 A1
(43) Pub. Date: Dec. 18, 2003

(54) System and method for classifying a financial transaction

(76) Inventors: Dara S. Davis, Lebanon, TN (US); Randy L. Hall, Nashville, TN (US); Frederick Martin, Hendersonville, TN (US); Linda R. McLeod, Mt. Juliet, TN (US); Diane M. Rezaii, Hermitage, TN (US); William E. Taylor, Franklin, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/172,954

(22) Filed: Jun. 17, 2002

(51) Int. Cl. G06F 17/60

(52) U.S. Cl. 705/35

(57) ABSTRACT

A computer based system and method automatically classifies a financial transaction. The system and method establish a set of parameters associated with the financial transaction and classify the financial transaction as a function of the set of parameter.

### TECHNICAL FIELD

The present invention relates generally to the sale and leasing of equipment, and more particularly, to a computer based system and method for classifying a financial transaction.

### BACKGROUND

The purchase or lease of equipment, such as construction or agricultural equipment, engines, etc., is a very detailed process involving complicated financing decisions and financial documents. The process involves determining the type of financing available for the customer, as well as geographic factors. Additionally, depending on the type of financing and the geographic location of the customer, the number, type, as well as the terms of, the documents required vary. From the seller's perspective, for tax and reporting purposes it is important that once a transaction has been closed that it be classified correctly.

In a typical sale or lease, the first step includes a quoting process. The quoting process involves a discussion with the customer, generally, including determining the equipment which the customer desires to lease or purchase and type and size of desired payment.

The second step is the credit process. The credit process involves requesting and receiving the customer credit scoring from credit bureaus. The credit scoring is used to determine the type of financing available to the customer. Other factors, may also be used to determine the type of financing available, such as the customer's payment history on past purchases or leases.

Once the financing terms have been arranged, the financing documents must be prepared. As discussed above, the number and type of documents, as well as specific clauses or terms in the financing documents will vary. Factors include customer, lessor, geographic location, and type of financing.

Recently, one or more of the above steps have utilized computer software programs to automate various sub-steps of the process. Other portions of the process may be done manually. One or more of the computer software programs and/or steps performed manually may classify a given transaction for tax and reporting purposes. This presents several problems.

For example, the rules for classifying transactions may change or the interpretation of a given rule may change. For those processes that are done manually, a transaction may be classified incorrectly because a person is not applying the rules correctly or the person may not have been trained in the most current rules.

With regard to the steps performed by computer programs, in general, the rules are typically part of the computer program. In other words, they are written into the computer program by the programmer or vendor of the program. If a change is required, it is difficult for the user of the system to make the desired changes. It is either more efficient for the same programmer or vendor to modify the software or the same vendor must modify because the user does not have access to the source code.

The present invention is aimed at one or more of the problems discussed above.

### SUMMARY OF THE INVENTION

In one aspect of the present invention, a computer based method for automatically classifying a financial transaction for an item is provided. The method includes the steps of establishing a set of parameters associated with the financial transaction and classifying the financial transaction as a function of the set of parameters.

In another aspect of the present invention, a computer based system for automatically classifying a financial transaction for an item is provided. The computer based system includes a database for storing a set of predetermined rules and a controller coupled to the database. The controller is adapted to receive a set of parameters associated with the financial transaction and to classify the financial transaction as a function of the set of parameters and the set of predetermined rules.

### BRIEF DESCRIPTION OF THE DRAWINGS

FIG. 1 is a flow diagram of a transaction process including a financial transaction classification process, according to an embodiment of the present invention;

FIG. 2 is a block diagram of a system for automatically classifying a transaction;

FIG. 3 is a block diagram of a computer program product for automatically classifying a transaction, according to an embodiment of the present invention;

FIG. 4 is a block diagram of a computer program product for automatically classifying a transaction, according to another embodiment of the present invention;

FIG. 5 is a first flow diagram of a method for automatically classifying a transaction, according to an embodiment of the present invention;

FIG. 6 is a second flow diagram of a method for automatically classifying a transaction, according to an embodiment of the present invention;

FIG. 7 is a third flow diagram of a portion of a method for automatically classifying a transaction, according to an embodiment of the present invention;

FIG. 8 is a graphical illustration of a first portion of a graphical user interface, according to an embodiment of the present invention;

FIG. 9 is a graphical illustration of a second portion of a graphical user interface, according to an embodiment of the present invention;

FIG. 10 is a graphical illustration of a third portion of a graphical user interface, according to an embodiment of the present invention;

FIG. 11 is a graphical illustration of a fourth portion of a graphical user interface, according to an embodiment of the present invention;

FIG. 12 is a graphical illustration of a fifth portion of a graphical user interface, according to an embodiment of the present invention;

FIG. 13 is a graphical illustration of a sixth portion of a graphical user interface, according to an embodiment of the present invention;

FIG. 14 is a graphical illustration of a seventh portion of a graphical user interface, according to an embodiment of the present invention;

FIG. 15 is a graphical illustration of an eighth portion of a graphical user interface, according to an embodiment of the present invention;

FIG. 16 is a graphical illustration of a ninth portion of a graphical user interface, according to an embodiment of the present invention;

FIG. 17 is a graphical illustration of a tenth portion of a graphical user interface, according to an embodiment of the present invention;

FIG. 18A is a graphical illustration of an eleventh portion of a graphical user interface, according to an embodiment of the present invention;

FIG. 18B is a second graphical illustration of the eleventh portion of the graphical user interface of FIG. 18A;

FIG. 19A is a graphical illustration of an twelfth portion of a graphical user interface, according to an embodiment of the present invention;

FIG. 19B is a second graphical illustration of the twelfth portion of the graphical user interface of FIG. 19A;

FIG. 20A is a graphical illustration of a thirteenth portion of a graphical user interface, according to an embodiment of the present invention; and,

FIG. 20B is a second graphical illustration of a the thirteenth portion of the graphical user interface of FIG. 20A.

### DETAILED DESCRIPTION

With reference to the drawings, and in operation, the present invention provides a computer based system 200 and a method 400 for classifying a transaction related to items or equipment, such as agricultural or construction equipment, engines, or any equipment or item which may be the subject of a financial transaction. The equipment or item may include any product or service that may by the subject of a financial transaction.

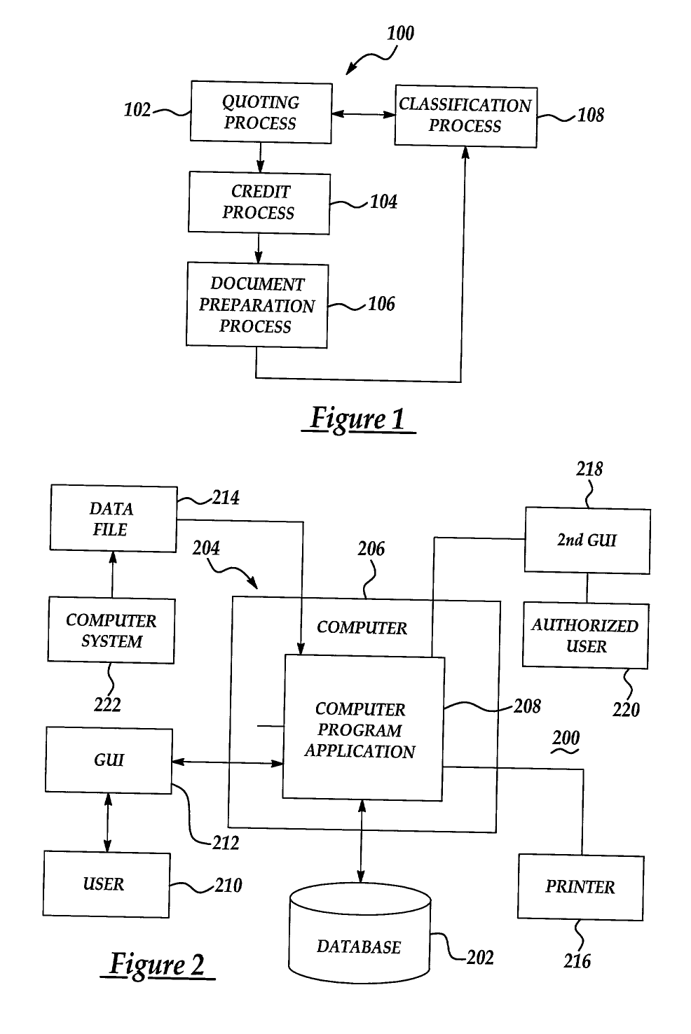

With specific reference to FIG. 1, the present invention may be utilized during the creation of a purchasing or leasing transaction 100 for equipment. The creation process may include: a quoting process (flow block 102), a credit process (flow block 104), a document preparation process (flow block 106), and a classification process (flow block 108). After the documents have been prepared and the transaction finalized, the sale or the lease of the subject matter of the transaction may be ordered or “booked”. The transaction may be classified using the classification process 108 at different times during the transaction 100. For example, the classification process 108 may be needed during the quoting 102 and/or the document preparation process 106.

Generally, a customer desires to purchase or lease one or more pieces of equipment or item. The customer contacts a sales agent, who may be located at either a dealer of the equipment or item or at a financing company. Alternatively, the customer may interact with a user interface implemented on a computer network, e.g., a website on the internet or an intranet.

In the quoting process 102, the agent works with the customer and determines the equipment or item which the customer wished to purchase or lease and the monthly payment the customer desires.

In the credit process 104, the sales agent requests a credit scoring for the customer from one or more credit bureaus. This information, along with other information regarding the customer's history with the financing company, is used to determine whether to extend credit to the customer for the purchase or lease of the equipment and, if so, under what terms.

During the quoting and credit processes 102, 104, the sales agent requests and receives, from the customer, transaction information. As described below, the agent enters this information into the system 200.

In one embodiment, the sales agent may enter a classification for the transaction, i.e., a desired classification or a “best-guess” classification. As discussed below, the computer system 200 may classify the transaction, compare its classification with the desired or best-guess classification. This may be accomplished by feeding the classification back into the quoting process. If the classifications are the same, the computer system 200 confirms the classification. However, if the classifications are different, the computer system 200 will relay the correct classification, as well as the reasons why the desired or best guess classification is wrong.

Alternatively, another computer system or program used during the transaction process may determine (using its own rules or logic) its own classification and relay its classification to the computer system 200. For example, a leasing system may be used to assist in putting together a leasing transaction and to assemble the documents. In a similar manner, the computer system 200 may classify the transaction, compare its classification with the received classification and confirm the classification if both are the same. However, if the classifications are different, the computer system 200 may relay the correct classification, as well as the reasons why the received classification is wrong.

With specific reference to FIG. 2, the computer system 200 for classifying the transaction, according to an embodiment of the present invention, will now be described.

The system 200 includes a database 202 for storing a predetermined set of rules and a controller 204 coupled to the database 202. The controller 204 is adapted to run a computer program application 208 in a conventional manner (see below). In one embodiment, the controller 204 is a stand alone computer 206 operable by a user 210 through a graphical user interface (GUI) 212.

In another embodiment, the computer 206 is part of a computer network (not shown), such as the internet. The GUI 212 may be run on a second computer (not shown) connected to the network. The GUI 212 may be implemented via a web enabled browser computer program, such as, Microsoft Internet Explorer.

The set of rules stored in the database 202 are used to classify a transaction. The set of rules may be defined and/or modified by another user, such as an administrator (see below). The set of rules may include tax rules and/or accounting rules, e.g., Generally Accepted Accounting Practices (GAAP).

In one embodiment, the computer program application 208 is adapted to receive a country associated with the financial transaction and a set of parameters associated with the financial transaction and to classify the financial transaction as a function of the country, the set of parameters, and the set of predetermined rules.

In another embodiment, the computer program application 208 is adapted to receive a set of parameters associated with the transaction. The set of parameters may include a term having an end and being associated with the transaction, an economic life of the item, a payment amount and a frequency of payment, a value associated with the item at the end of the term, and a rate related to the transaction. The computer program application 208 is further adapted to classify the transaction as a function of the set of parameters.

Additionally, the computer program application 208 may be adapted to request or receive updates of the set of parameters. In one embodiment, the computer program application 208 may be adapted to periodically request parameter updates. For example, the computer program application 208 may periodically access another computer system or database (not shown) that contains the GAAP to determine if there are any updates. Alternatively, the another computer system or database may be adapted to periodically and/or automatically provide any updates to the computer program application 208.

The user 210 may input the set of parameters and/or the country to the system 200 through the GUI 212. Alternatively, the set of parameters and/or the country may be entered into the system 200 through a data file 214 or passed to the system 200 from another computer program or system 222.

In one embodiment, the transaction is classified as either a lease or a purchase. In another embodiment, the transaction is classified as one of an operating lease, a true lease, a lease purchase and an installment sales contract, e.g., a promissory note or a governmental lease purchase. In one embodiment, the classification may be based on the country, the set of parameters and a set of predetermined rules. These terms are generally defined below per US Tax and US GAAP rules. However, each country may define the book and income tax terms differently. For a particular set of country, state and local tax rules, the jurisdictional definitions will be applied.

Operating Leases are leases that are fixed assets for book purposes, which may or may not pass the tax rules. The set of rules are applied to the lease and include a four item-test. If the contract does not pass any of the four tests then it will be considered an operating lease. Under an operating lease, the lessor has ownership of the asset for book purposes and generally has ownership for tax purposes. The lessee or customer is simply paying for the use of the asset and has no equity built up in the asset. In general, the four tests are:

the lease period is more than a percentage, e.g., 75%, of the economic life of the asset

the payments are more than a percentage, e.g., 90%, of the net present value (NPV) of the asset

there is an automatic transfer of the asset at the end of the lease; and

the lease contains a bargain purchase option.

True Lease are leases in which there is no equity built up by the customer in the equipment. In general, if there is equity built up, then the customer may be buying the equipment, as opposed to leasing it. If the agreement or contract is structured such that the customer is buying the equipment, then the lessor does not get to declare the depreciation of the equipment. If the lease is a true lease, then the financing company will not own the equipment for book purposes, but will be the owner for tax purposes. For example, under a true lease, the financing company would be able to declare accelerated depreciation for Federal and State income tax purposes. However, this would not affect the determination of the state's sales tax since each state's sales tax rules are independent of the income tax rules.

Lease Purchase: Under a lease purchase, the financing company purchases the equipment and sells to the lessee via a lease purchase. The customer builds up equity in the equipment during the course of the lease. The customer may have a bargain option for the purchase of the equipment at the end of the lease and have accumulated equity in the equipment at that time. Therefore, the lessee may normally take the depreciation in the equipment.

Installment Sales Contract: Under an installment sales contract, the financing company buys the contract, not the equipment. Thus, the customer and the dealer are responsible for the sales and/or use taxes.

In one embodiment the controller 208 is adapted to determine if the transaction is an operating lease as a function of the country, the set of parameters, and the set of predetermined rules, and to responsively classify the transaction as an operating lease.

If the transaction is not an operating lease, the controller 206 is adapted to determine if the transaction is a true lease as a function of the country, the set of parameters, and the set of predetermined rules, and responsively classify the transaction as a true lease.

In another embodiment, the controller 208 is adapted to further classify the transaction according to internal or user requirements, based on, for example, US tax rules. The additional classifications may be used for additional tax, financial, or internal reporting.

If the transaction is not a true lease, the controller 208 is adapted to determine if the transaction is a lease purchase as a function of the country, the set of parameters, and the set of predetermined rules, and responsively classify the transaction as a lease purchase.

In one aspect of the present invention, the set of parameters may include an option value, a term associated with the transaction, and a value associated with the item at the end of the term. The controller 208 is adapted to compare the option value with the value associated with the item at the end of the term.

In one embodiment, the value associated with the item at the end of the term is a fair market value and the transaction is a true lease if the option value is greater than the fair market value.

In another embodiment of the present invention, the value associated with the item at the end of the term is a value option (VO) and the transaction is not a true lease if the option value is not greater than the fair market value.

In still another embodiment of the present invention, the value associated with the item at the end of the term is a residual value and the transaction is not an operating lease if the option value is less than a predetermined percentage of the residual value.

In another aspect of the present invention, the set of parameters includes an economic life of the item and a term associated with the transaction. The transaction is not an operating lease if the term is equal or greater than a percentage, e.g., seventy-five percent, of the economic life of the item.

In another aspect of the present invention, the set of parameters includes a net present value of minimum lease payments and a cost of the item. The controller is adapted to compare the net present value with the cost of the item. In one embodiment, the transaction is not an operating lease if the net present value of the minimum lease payments is greater or equal to ninety percent (90%) of the cost of the item.

In another aspect of the present invention, the set of parameters includes a residual value and an original equipment cost. The controller 208 is adapted to compare the residual value to the original equipment cost. In one embodiment of the present invention, the transaction is not a true lease if the residual value is less than a predetermined percentage of the original equipment cost.

In another aspect of the present invention, the set of parameters includes an option amount and a residual value. The controller 208 is adapted to compare the option amount and the residual value. In one embodiment, the transaction may not be a lease purchase requirement if the option amount is greater or equal to a fixed percentage of the residual value.

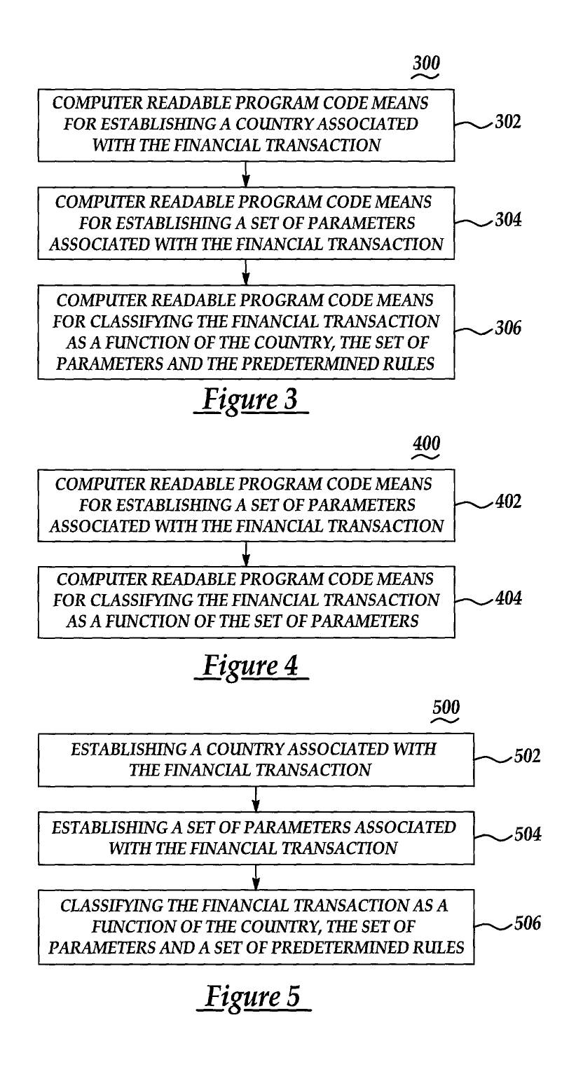

With reference to FIG. 3, in one embodiment, a computer program product 300 may classify a financial transaction in an automated or automatic manner. The computer program product 300 includes computer readable program code means 302 for establishing a country associated with the financial transaction, computer readable program code means 304 for establishing a set of parameters associated with the financial transaction, and computer readable program code means 306 for classifying the financial transaction as a function of the country, the set of parameters, and a set of predetermined rules. The set of parameters and set of predetermined rules may be user specified (see below).

With reference to FIG. 4, in another embodiment, a computer program product 400 may classify a financial transaction for an item. The computer program product 400 includes computer readable program code means 402 for establishing a set of parameters associated with the transaction. The set of parameters including a term having an end and being associated with the transaction, an economic life of the item, a payment amount and a frequency of payment, a value associated with the item at the end of the term, and a rate related to the transaction. The computer program product 400 may also include computer readable program code means 404 for classifying the transaction as a function of the set of parameters.

With reference to FIG. 5, a computer based method 500, according to one embodiment of the present invention, classifies a financial transaction for an item. In a first process block 502, a country associated with the financial transaction is established. In a second process block 504, a set of parameters associated with the financial transaction is established. As discussed above, the country and the set of parameters may be input by the user 210 or read from the data file 214 which is received from another computer system 222. In a third process block 506, the financial transaction is classified as a function of the country, the set of parameters, and a set of predetermined rules.

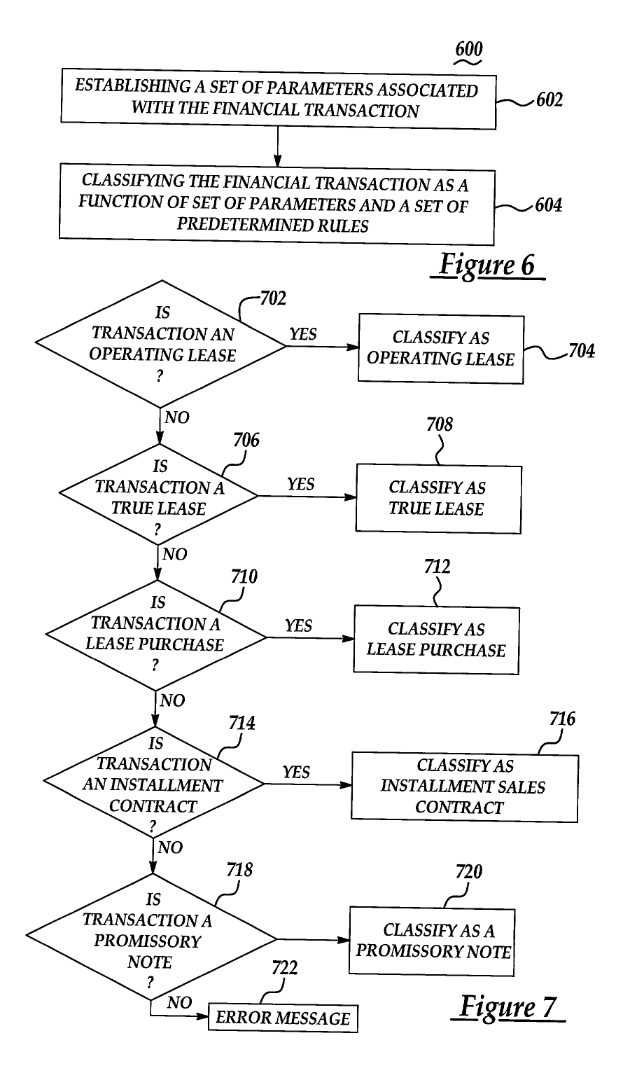

With reference to FIG. 6, a computer based method 600, according to another embodiment of the present invention, classifies a financial transaction for an item. In a fourth process block 602, a set of parameters associated with the transaction is established. The set of parameters may include a term having an end and being associated with the transaction, an economic life of the item, a payment amount and a frequency of payment, a value associated with the item at the end of the term, and a rate related to the transaction. In a fifth process block 604, the transaction is classified as a function of set of parameters.

In one embodiment, the transaction is classified as one of an operating lease, a true lease, a lease purchase, an installment sales contract, or a promissory note. With reference to FIG. 7, in one embodiment, the step of classifying the transaction includes several sub-steps. In a first decision block 702, the method 500, 600 determines if the transaction is an operating lease. If yes, then the financial transaction is classified as an operating lease in a sixth process block 704. In a second decision block 706, if the transaction is not an operating lease, the method 500, 600 determines if the transaction is a true lease. If yes, then the financial transaction is classified as a true lease in a seventh process block 708.

In a third decision block 710, if the transaction is not a true lease, then the method 500, 600 determines if the transaction is a lease purchase. If yes, then the transaction is classified as a lease purchase in an eighth process block 712. In a fourth decision block 714 if the transaction is an installment sales contract, then the transaction is classified as an installment sales contract in a ninth process block 716. In a fifth decision block 718 if the transaction is a promissory note, then the transaction is classified as a promissory note in a tenth process block 720. Otherwise, an error message is transmitted to the use 210 in eleventh process block 722.

With reference to FIGS. 2, and 8-19B, in another aspect of the present invention, an authorized user 220 is allowed to define and modify the set of parameters for a specific country. In another aspect of the present invention, the present invention allows the authorized user 220 to define and/or modify the predetermined rules as a function of the set of parameters.

Returning to FIG. 2, the system 200 includes a second graphic user interface (GUI) 218. The second graphic user interface 218 is utilized by the authorized user 220. In one embodiment, the first and second GUI 212, 218 may be combined into a single GUI.

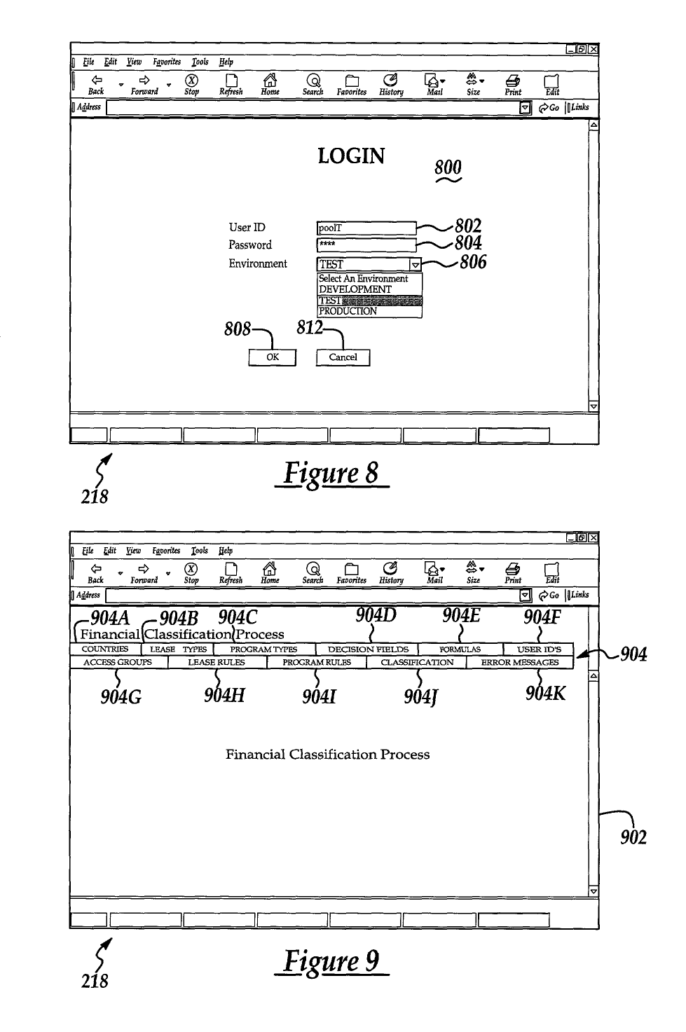

With specific reference to FIG. 8, the second GUI includes a login screen 800. The login screen 800 includes a user ID text entry box 802, a password entry box 804, and an environment drop down list 806. The authorized user 220 enters their ID and password in the entry boxes 802, 804 and selects the appropriate environment based on the type of user. For example, in the illustrated embodiment, the authorized user 220 selects from a development, test, and production environment. Access to the various environments is based on the rights of the authorized user 220. The login screen 800 also includes an OK button 808 and a CANCEL button 810. After the authorized user 220 enters their information and selects an appropriate environment, the authorized user 220 may select the OK button 808 to gain entry to the system 200.

With reference to FIG. 9, once the authorized user 220 has gained entry, a Financial Classification Process (FCP) screen 902 is displayed by the graphical user interface 218. The FCP screen 902 includes a plurality of tabs 904. In the illustrated embodiment, the plurality of tabs includes a Countries tab 904A, a Lease Types tab 904B, a Program Types tab 904C, a Decision Fields tab 904D, a Formulas tab 904E, a User Ids tab 904F, an Access Groups tab 904G, a Lease Rules tab 904H, a Program Rules tab 9041, a Classification tab 904J, and an Error Messages tab 904K. The selection of a tab by the authorized user is restricted based on his/her access level.

Selection of one of the tabs 904A-904K displays a corresponding panel in the FCP screen 902 (see below). The purpose of each panel will be described below. The panels displayed upon selection of the Countries tab 902A, Access Groups tab 904G, and Error Messages tab 904K are used for maintenance. The panel displayed upon selection of the Classification tab 904J is used during testing or by users whose systems are not tied to other systems and must enter data manually (see below).. The other panels are used to define and modify the set of parameters and the rules used by the system 200 and the method 500, 600. Furthermore, the selection of a tab by the authorized user 220 may be restricted based on the authorized user's access level.

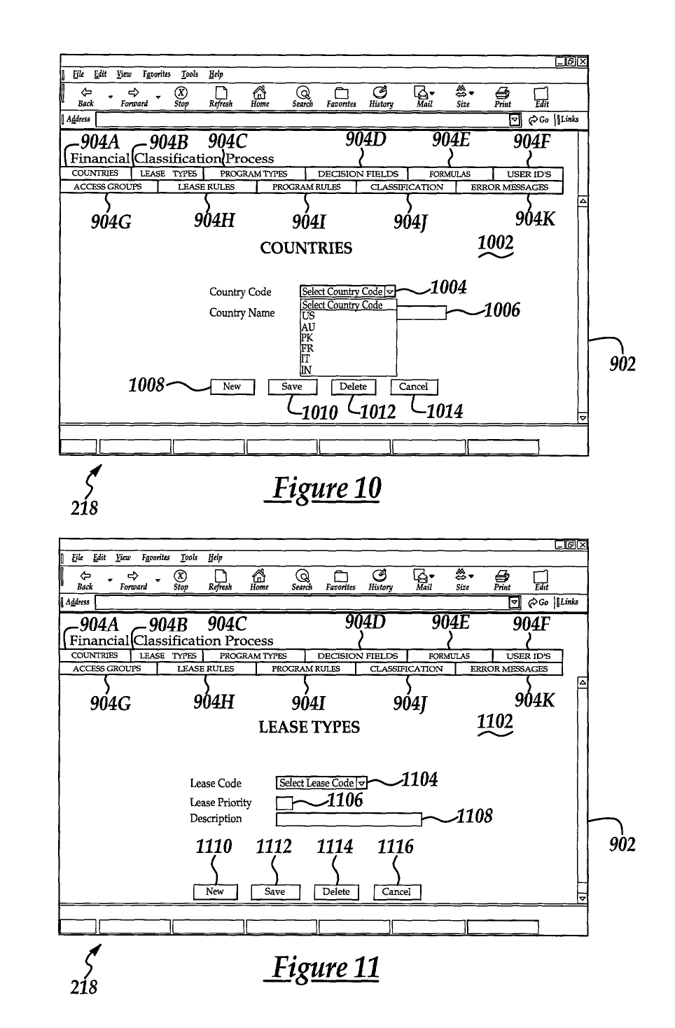

With specific reference to FIG. 10, upon selection of the Countries tab 904A, a Countries panel 1002 is displayed in the FCP screen 902. The Countries panel 1002 includes a Country Code drop down list 1004 and a Country Name text entry box 1006. The Countries panel 1002 also includes a New button 1008, a Save button 1010, a Delete button 1012, and a Cancel button 1014. The Countries panel 1002 is used by the authorized user 220 to add and/or modify the countries defined within the system 200 and method 500, 600. The authorized user 220 may enter or modify data pertaining to a country in the Country Code drop down list 1004 and Country Name text entry box 1006. The new or modified country data can be added or saved to the database 202 by actuation of the Save button 1010. Actuation of the New button 1008 results in the Country Code drop down list 1004 being replaced with an entry box. The authorized user 220 may enter a new country code with the entry box. Actuation of the Delete button 1012 results in a selected country being deleted from the database 202. Actuation of the Cancel button 1014 clears the Country Code drop down list 1004 and the Country Name text entry box 1006.

With specific reference to FIG. 11, upon selection of the Lease Types tab 904B, a Lease Types panel 1102 is displayed in the FCP screen 902. The Lease Types panel 1102 includes a Lease Code drop down list 1104, a Lease Priority entry box 1106 and a Description text entry box 1108. The Lease Types panel 1102 also includes a New button 1110, a Save button 1112, a Delete button 1114, and a Cancel button 1116. The Lease Types panel 1002 is used by the authorized user 220 to add and/or modify the lease types defined within the system 200 and method 500, 600. The authorized user 220 may enter or modify data pertaining to a lease type in the Lease Code drop down list 1104, Lease Priority text entry box 1106 and the Description text entry box 1108. The new or modified lease type data can be added or saved to the database 202 by actuation of the Save button 1112. Actuation of the New button 1110 results in the Lease Code drop down list 1104 being replaced with an entry box. The authorized user 220 may enter a new lease type code in the entry box. Actuation of the Delete button 1114 results in a selected lease type being deleted from the database 202. Actuation of the Cancel button 1114 clears the Lease Code drop down list 1104 and the Description text entry box 1106.

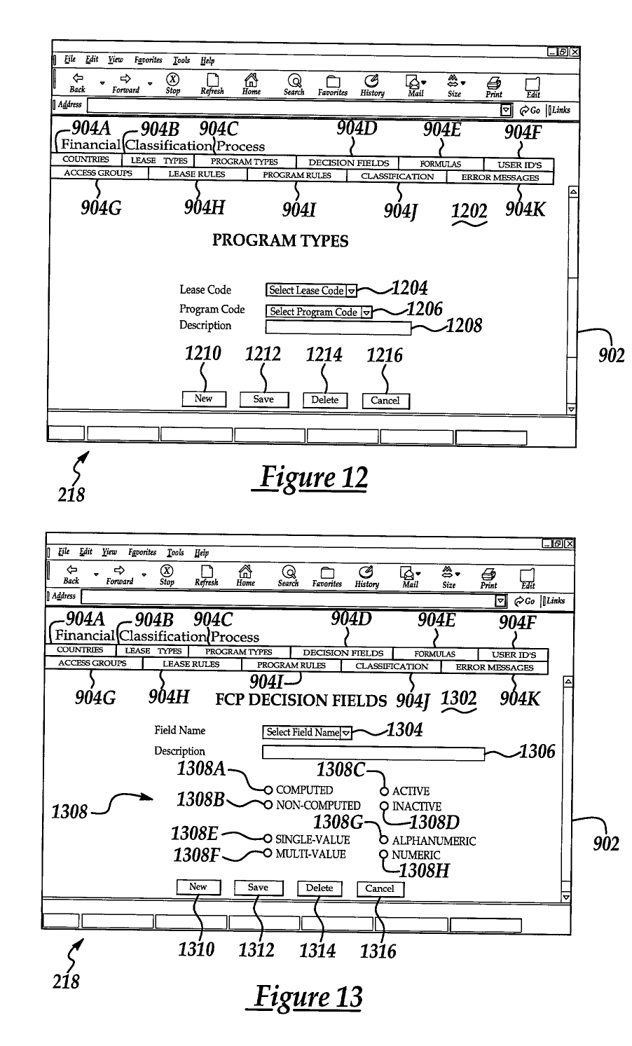

With specific reference to FIG. 12, upon selection of the Program Types tab 904C, a Program Types panel 1202 is displayed in the FCP screen 902. The Program Types panel 1202 includes a Lease Code drop down list 1204, a Program Code drop down list 1206, and a Description text entry box 1208. The Program Types panel 1202 is used to define Program Types for the lease types defined in the Lease Types panel 1102. Program Types are sub-types of leases. The Program Types panel 1202 also includes a New button 1210, a Save button 1212, a Delete button 1214, and a Cancel button 1216. The Program Types panel 1202 is used by the authorized user 220 to add and/or modify the program types defined within the system 200 and method 500, 600. The authorized user 220 may enter or modify data pertaining to a program type in the Program Type drop down list 1206 and the Description text entry box 1208. The new or modified program type data can be added or saved to the database 202 by actuation of the Save button 1212. Actuation of the New button 1210 results in the Program Code drop down list 1206 being replaced with an entry box. The authorized user 220 may enter a new program code in the entry box. Actuation of the Delete button 1214 results in a selected program type code being deleted from the database 202. Actuation of the Cancel button 1014 clears the Lease Code drop down list 1204, the Program Code drop down list 1206, and the Description text entry box 1206.

With specific reference to FIG. 13, upon selection of the Decision Fields tab 904D, a Decision Fields panel 1302 is displayed in the FCP screen 902. The Decision Fields panel 1302 includes a Field Name drop down list 1304 and a Description text entry field 1306. The Decision Fields panel 1302 also includes a plurality of parameter check boxes 1308 which are used to define the decisions fields. In the illustrated embodiment, the plurality of parameter check boxes includes a computed check box 1308A, a non-computed check box 1308B, an active check box 1308C, an inactive check box 1308D, a single-value check box 1308E, a multi-value check box 1308F, an alphanumeric check box 1308G, and a numeric check box 1308H.

The Decision Fields panel 1302 also includes a New button 1310, a Save button 1312, a Delete button 1314, and a Cancel button 1316. The Decision Fields panel 1302 is used by the authorized user 220 to add and/or modify the fields which will be used within the rules defined within the system 200 and method 500, 600 (see below). The authorized user 220 may enter or modify data pertaining to a decision field in the field name drop down list 1304 and the Description text entry box 1308. The new or modified decision field can be added or saved to the database 202 by actuation of the Save button 1312. Actuation of the New button 1310 results in the Decision Fields drop down list 1306 being replaced with an entry box. The authorized user 220 may enter a new decision field name in the entry box. Actuation of the Delete button 1314 results in a selected decision field being deleted from the database 202. Actuation of the Cancel button 1314 clears the Decision Field drop down list 1304, the Description text entry box 1206, and the check boxes 1308.

The Computed and Non-Computed check boxes 1308A, 1308B are mutually exclusive and define whether the defined field is computed via or a formula or a given value or values. The Active and Inactive checkboxes 1308C, 1308D are mutually exclusive and define whether the defined field is active or inactive.

The Single-Value and Multi-Value check boxes 1308E, 1308F are active only if the Non-Computed check box 1308B is selected and define whether there is a single value or multiple values associated with the defined field.

The Alphanumeric and Numeric check boxes 1308G, 1308H are active only if the Non-Computed check box 1308B is selected and define whether the field can contain any alphanumeric character or only numerals.

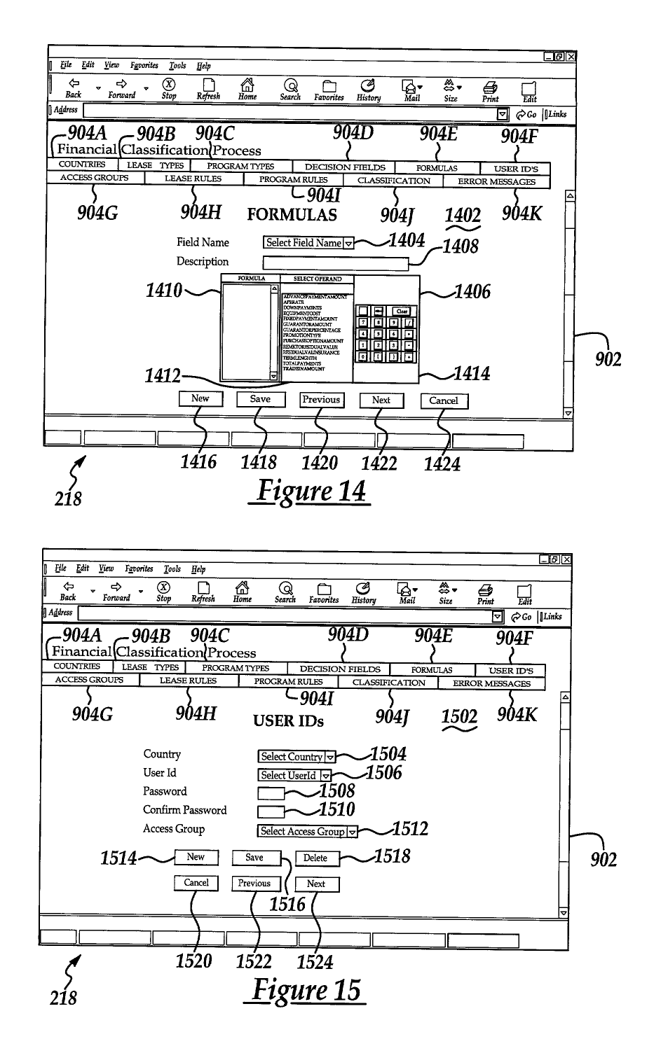

With specific reference to FIG. 14, upon selection of the Formulas tab 904E, a Formulas panel 1402 is displayed in the FCP screen 902. The Formulas panel 1402 allows the authorized user 220 to define the formulas for those field names indicated as computed fields on the Decision Fields panel 1302. The Formulas panel 1402 includes a Field Name drop down list 1404, a Formula text entry box 1406, and a Description text entry box 1408. The Field Name drop down list 1404 is populated with those fields which are designated as computed and numeric in the Decision Fields panel 1302. In order to define the formula for a defined field, the authorized user 220 selects the desired field in the Field Name drop down list 1404 and adds a description in the Description text entry box 1408. The formula for the selected field is entered in the Formula text entry box and may include defined fields and one or more mathematical operators. In one embodiment, the mathematical operators available include addition, subtraction, multiplication, division and parentheses and brackets.

The Formulas panel 1402 includes a Formula List 1410, a List of Operands 1412 and a Keypad 1414 for entering and modifying formulas.

Once a Field Name is selected in the Field Name drop down list 1404, if a formula has already been defined, the formula is displayed in the Formula List 1410. If a formula has not been defined, the Formula List will remain blank. Using the List of Operands 1412 and the Keypad 1414, the formula for the selected Field Name may be defined or modified. Numbers (i.e., constants) and mathematical operators are entered using the keypad 1406. The List of Operands 1412 is populated with those fields defined as non-computed and numeric in the Decision Fields panel 1302. In one embodiment, these fields may be added to the current formula by “double-clicking” on their name in the List of Operands 1412.

In one embodiment, operation of the Formulas panel 1402 and the formulas follow a set of predetermined rules. For example, after a Field Name has been added to the formula, a mathematical operator must be added via the keypad 1406. Additionally, formulas are followed using the following precedence: brackets over division, multiplication, addition, and subtraction (BDMAS).

The Formulas panel 1402 also includes a New button 1416, a Save button 1418, a Previous button 1420, a Cancel button 1422, and a Next button 1422. The Previous and Next Buttons 1420, 1424 are used to navigate up and down the list of defined fields. The New Button 1416 clears the Field Name drop down list 1404, the Formula text entry box 1406, and the Description text entry box 1408. The Save button 1418 saves an entered formula in the database 202.

With reference to FIG. 15, upon selection of the User Ids tab 904F, a User Ids panel 1502 is displayed. The User Ids panel 1502 is used to create and modify User Ids for users or authorized users of the system 200 and method 500, 600. The User Ids panel 1502 includes a Country drop down list 1504, a User Id drop down list 1506, a Password text entry box 1508, a Confirm Password text entry box 1510, and an Access Group drop down list 1512. The User Ids panel 1502 also includes a New button 1514, a Save button 1516, a Delete button 1518, a Cancel button 1520, a Previous button 1522, and a Next button 1524.

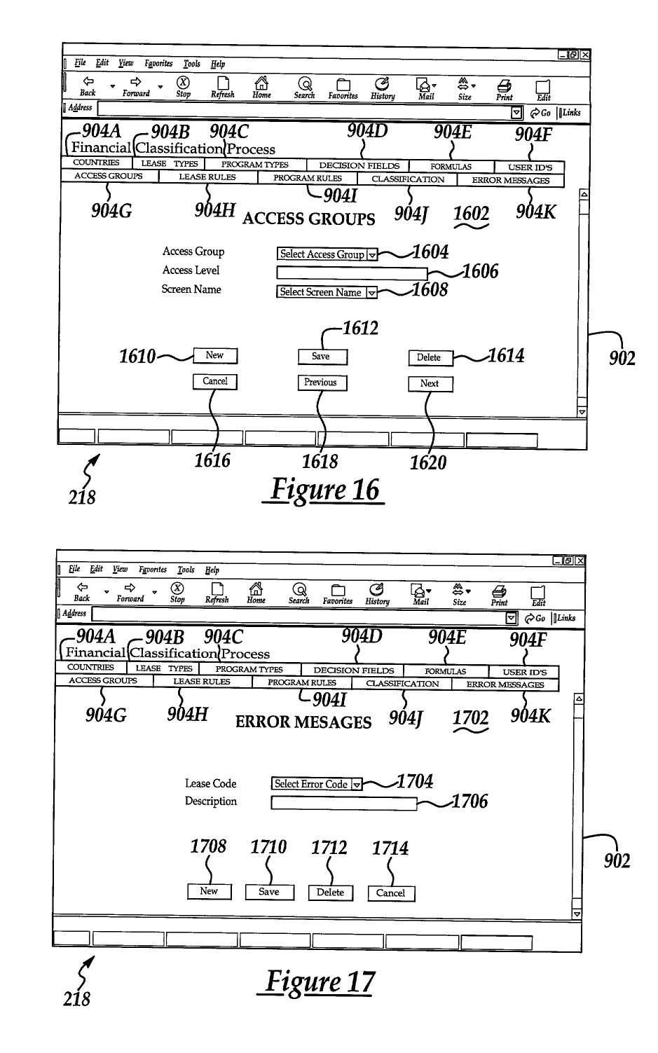

With reference to FIG. 16, upon selection of the Access Groups tab 904G, an Access Groups panel 1602 is displayed. The Access Groups panel 1602 is used to define Access Groups. Users may be defined as being a member of an Access Group for purposes of access to the system 200 and the method 500, 600. The Access Groups panel 1602 includes an Access Group drop down list 1604, an Access Level text entry box 1606, and a Screen Name drop down list 1608. The Access Groups panel 1602 also includes a New button 1610, a Save button 1612, a Delete button 1614, a Cancel button 1616, a Previous button 1618, and a Next button 1620. The User Ids panel 1502 and the Access Groups panel 1602 are used to define and modify authorized users and the define their level of access to the system 200.

With reference to FIG. 17, upon selection of the Error Messages tab 904K an Error Messages panel 1702 is displayed in the FCP screen 902. The Error Messages panel 1702 is used to define error messages which may be displayed during operation of the system 200 and method 500, 600. In one aspect of the present invention, the error message contain the reason or reasons a transaction does not fit a classification. The Error Messages panel 1702 includes an Error Code drop down list 1704 and an Error Message text entry box 1706. The Error Messages panel 1702 also includes a New button 1708, a Save button 1710, a Delete button 1712, and a Cancel button 1714. Selection of the New button 1708 causes the Error Code drop down list 1704 to be changed to a text entry box for entry of a new code. Selection of the Save button 1708 saves a newly entered or modified error code and description in the database 202. Selection of the Delete button 1712 deletes the selected error code from the database 202. Selection of the Cancel button 1714 resets the Error Messages panel 1702.

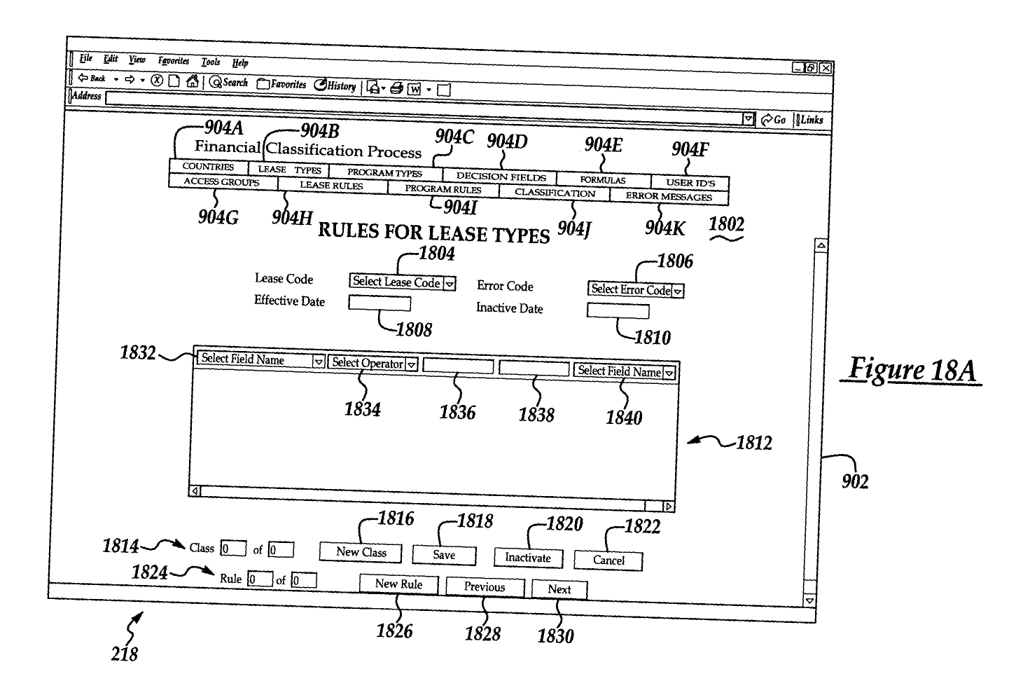

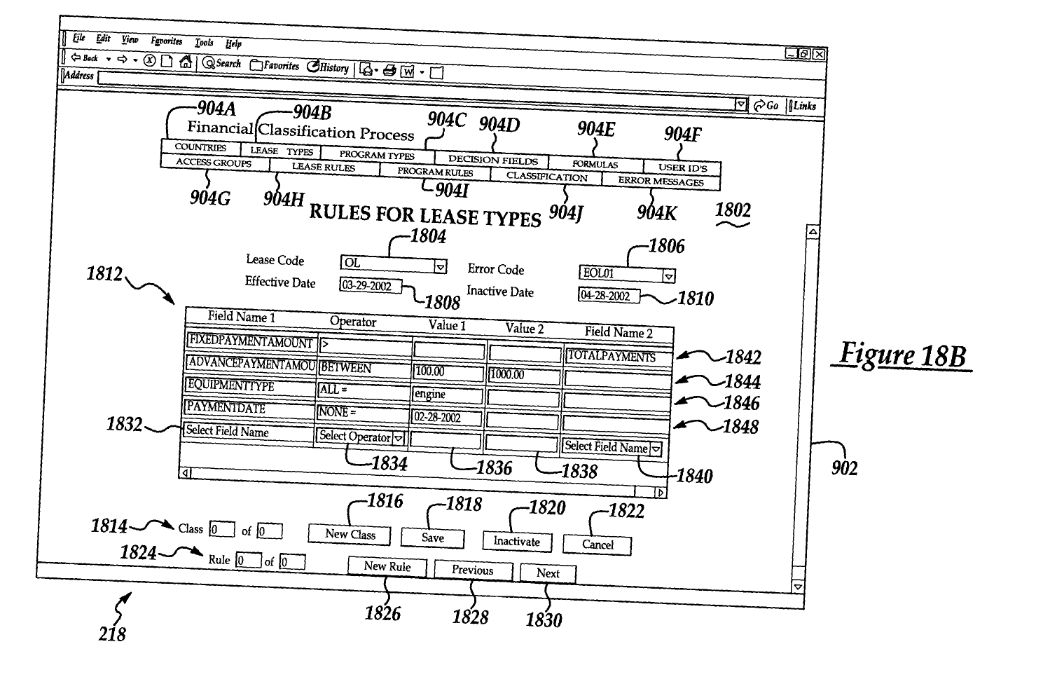

With reference to FIGS. 18A and 18B, upon actuation of the Lease Rules Tab 904H, a Lease Rules panel 1802 is displayed in the FCP screen 902. The Lease Rules Panel 1802 is used by the authorized user 220 to define the rules associated with each lease type previously defined.

In the illustrated embodiment, the Lease Rules panel 1802 includes a Lease Code drop down list 1804, an Error Code drop down list 1806, an Effective Date entry box 1808, and an Inactive Date entry box 1810. The Lease Rules panel 1802 also includes an entry box 1812 for entry of a rule (see below). The Lease Rules panel 1802 further includes a Class Counter 1814, a New Class button 1816, a Save button 1818, an Inactivate button 1820, and a Cancel button 1822. The Lease Rules panel 1802 also includes a Rule Counter 1824, a New Rule button 1826, a Previous button 1828, and a Next button 1830.

In the illustrated embodiment, the Lease Rules panel 1802 allows the authorized user to organize the rules for a given lease code into classes. The New Class button 1816, Save button 1818, Inactivate button 1820, Cancel button 1822, New Rule button 1826, Previous button 1828, and Next button 1830 allow the authorized user 220 to manipulate the sequences, rules and classes listed in the entry box 1812 (see below). The class and rule descriptors 1814, 1824 are used as indicators to the authorized user 220.

The entry box 1812 includes a Select Field Name 1 drop down list 1832, an Operator drop down list 1834, a Value 1 entry box 1836, a Value 2 entry box 1838, and a Select Field Name 2 drop down list 1840. The Select Field Name 1 drop down list 1832, the Operator drop down list 1834, the Value 1 entry box 1836, the Value 2 entry box 1838, and the Select Field Name 2 drop down list 1840 are used to define each rule. However it should be noted that not each of these is required for each rule. For example, a particular rule may be based on a single field and a single value.

More than one rule may be defined for each lease code. In one embodiment, rules are composed of sequences which are connected by an “AND” operator. Rules are grouped together into classes by “OR” operators. Furthermore, classes may be grouped together using “AND” operators.

Examples of several sequences which may be defined for an Operating Lease are illustrated in FIG. 18B. Each line in the entry box 1812 defines a sequence. In the illustrated example, first, second, third and fourth sequences are defined in first, second, third, and fourth lines 1842, 1844, 1846, 1848, respectively. In the first, second, third, and fourth lines 1842, 1844, 1846, and 1848, the following sequences are defined:

first line 1842: FIXEDPAYMENTAMOUNT>TOTALPAYMENTS

second line 1844: ADVANCEDPAYMENTAMOUNT BETWEEN 100 AND 1000

third line 1846: EQUIPMENTTYPE ALL=engine

fourth line 1848: PAYMENT DATE, NONE=Feb. 28, 2002

The first, second, third and fourth sequences are linked by AND operators into a single rule. In the illustrated embodiment, each of these sequences must be met in order for a particular transaction to be classified as an Operating Lease.

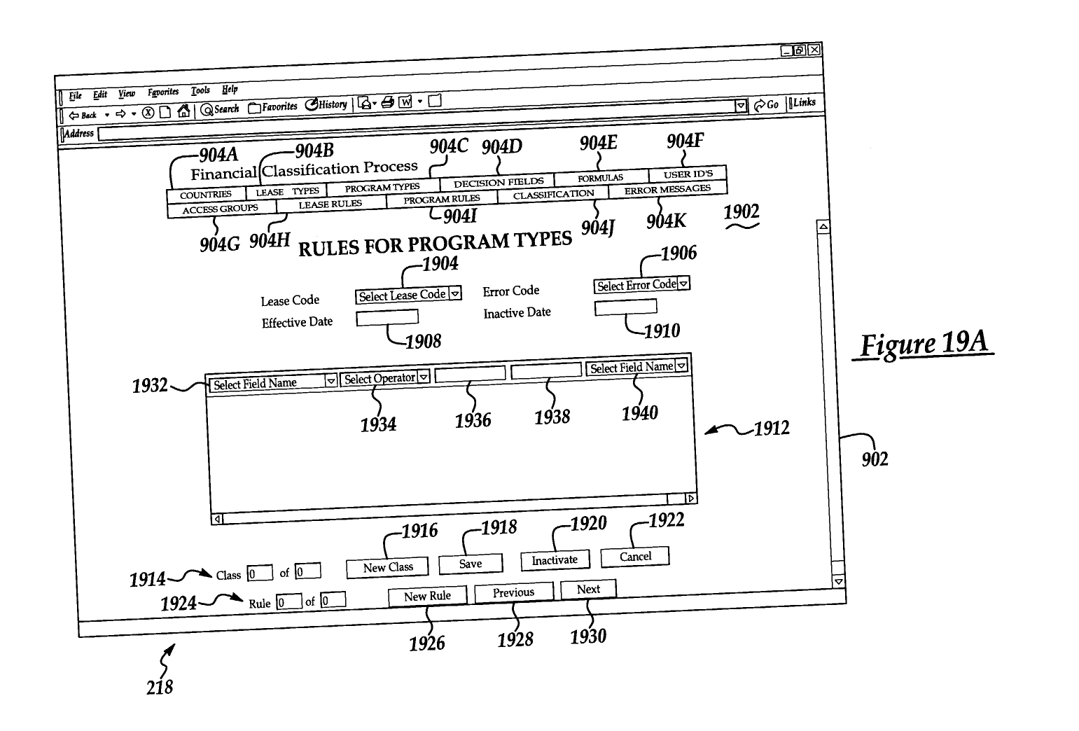

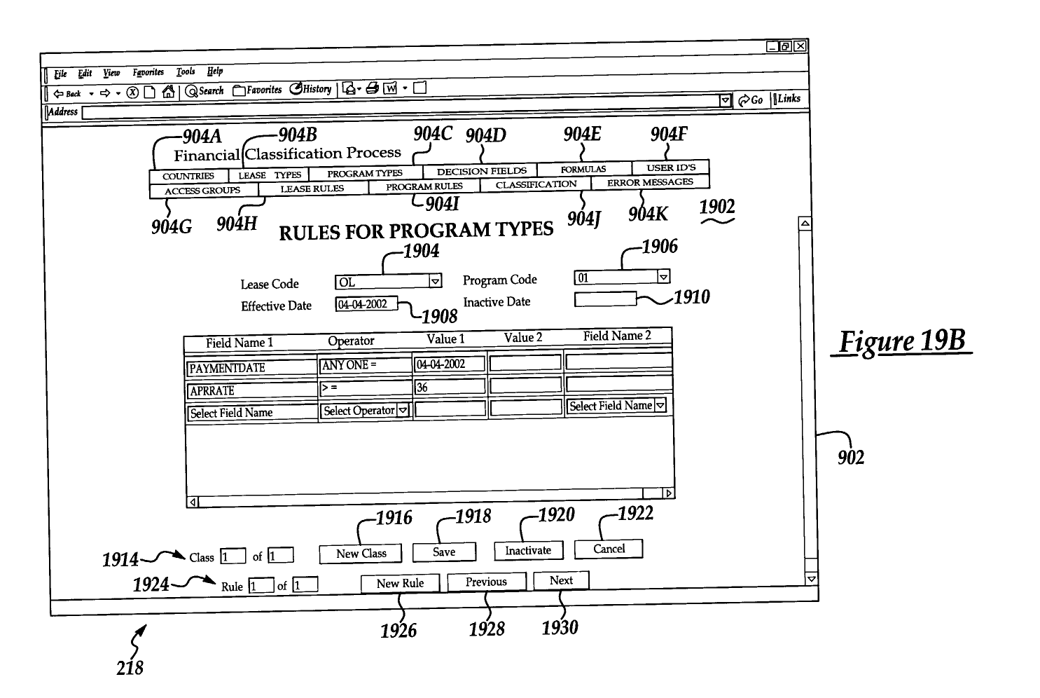

With reference to FIGS. 19A and 19B, upon actuation of the Program Rules Tab 904I, a Program Rules panel 1902 is displayed in the FCP screen 902. The Program Rules Panel 1902 is used by the authorized user 220 to define the rules associated with each program type (for each lease type) previously defined.

In the illustrated embodiment, the Program Rules panel 1902 includes a Lease Code drop down list 1904, a Program Code drop down list 1906, an Effective Date entry box 1908, and an Inactive Date entry box 1910. The Program Rules panel 1902 also includes an entry box 1912 for entry of a rule (see below). The Program Rules panel 1902 further includes a Class Counter 1914, a New Class button 1916, a Save button 1918, an Inactivate button 1920, and a Cancel button 1922. The Program Rules panel 1902 also includes a Rule Counter 1924, a New Rule button 1926, a Previous button 1928, and a Next button 1930.

In the illustrated embodiment, the Program Rules panel 1902 allows the authorized user 220 to organize the rules for a given program code into classes. The New Class button 1916, Save button 1918, Inactivate button 1920, Cancel button 1922, New Rule button 1926, Previous button 1928, and Next button 1930 allow the authorized user 220 to manipulate the classes and rules listed in the entry box 1912 (see below). The class and rule counters 1914, 1924 are used as indicators to the authorized user 220. Each program type is linked to a lease type.

The entry box 1912 includes a Select Field Name 1 drop down list 1932, an Operator drop down list 1934, a Value 1 entry box 1936, a Value 2 entry box 1938, and a Select Field Name 2 drop down list 1940. The Select Field Name 1 drop down list 1932, the Operator drop down list 1934, the Value 1 entry box 1936, the Value 2 entry box 1938, and the Select Field Name 2 drop down list 1940 are used to define each rule. However it should be noted that not each of these are required for each rule. For example, a particular rule may be based on a single field and a single value.

More than one rule may be defined for each program code. In one embodiment, rules are composed of sequences which are connected by an “AND” operator. Rules are grouped together into classes by “OR” operators. Furthermore, classes may be grouped together using “AND” operators.

Example of several sequences which may be defined for a program code of “01” under the lease type Operating Lease are illustrated in FIG. 19B. First and second sequences are defined in first and second lines 1942, 1944, respectively. In the first and second lines 1942, 1944, the following sequences are defined:

first line 1942: PAYMENTDATE ANYONE=Apr. 4, 2002

second line 1944: APRRATE>=36

The first and second sequences are linked by an AND operator into a single rule. In the illustrated embodiment, each of these sequences or conditions must be met in order for a particular transaction to be classified under Program Code 01 as an Operating Lease.

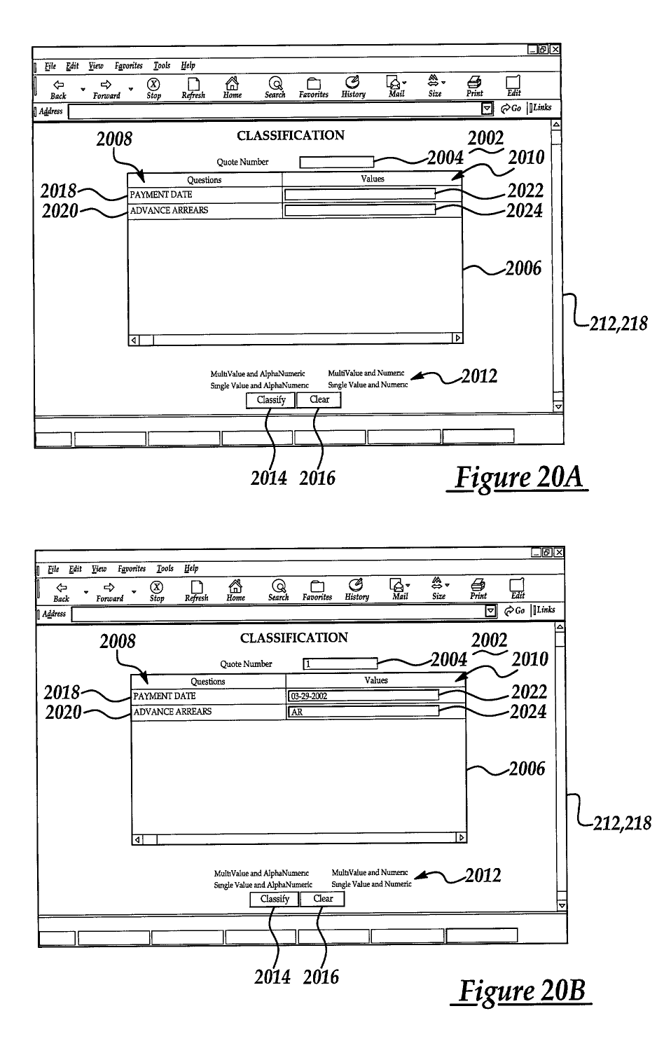

With reference to FIGS. 20A and 20B in another aspect of the present invention, a Classification Screen 2002 allows a user 210, 220 to directly enter the information required by the defined rules to classify a transaction. The Classification Screen 2002 may be provided to the user 210 for classifying actual transactions or to the authorized user 220 for testing of the defined rules. As such, the Classification Screen 2002 may be provided via the GUI 212, the second GUI 218, both GUIs or a combined GUI.

In the illustrated embodiment, the Classification Screen 2002 includes a Quote Number text box 2004 and an Input Table 2006. The Input Table 2006 includes a Questions column 2008 and a Values column 2010. The Classification Screen 2002 also includes an Information Section 2012, a Classify button 2014 and a Clear button 2016.

Each row of the Input Tale 2006 includes a single field or question for which input data is required. In each row, the Questions column 2008 includes the name of the Field for which a value or values are required. The user 210, 220 inputs the required data into Values column 2010 of the corresponding row. The Information Section 2012 provides an indication of the type of data required for a selected question or row of the input table 2006. In the illustrated embodiment, the type of data may be either a single value or multiple values and either numeric or alphanumeric.

In the illustrated embodiment, two required fields are shown: PAYMENT DATE and ADVANCE ARREARS. With specific reference to FIG. 20B, sample data of “Mar. 29, 2002” and “AR” are shown.

Industrial Applicability

With specific reference to the Figs., the present invention provides a system 200 and method 500, 600 for classifying a financial transaction. The system 200 and method 500, 600, in practice, may be part of a sale or lease transaction for, e.g., equipment or services. The customer (purchaser or lessee) interacts with an employee (sales agent) of a dealer, a financing company or the manufacturer.

As described above, there are generally four steps to the transaction: the quoting process, the credit process, the document preparation process, and the classification process. In the quoting process, the customer and the sales agent discuss the type and number of equipment, the type of contract, and the maximum size payment the client desires. After these are determined, the agent performs a credit check on the customer to determine whether or not to extend the desired credit to the customer. Past customer conduct with respect to payment history to the financing company may also be considered. After the credit process, the transaction documents need to be prepared. This may be done automatically using an auto-packaging computer application for generating a list of the required documents using information gathered during the quoting process and the credit process and a remote docs computer application (not shown) for preparing the documents. Alternatively, the required documents could be manually assembled.

Using the information provided during the above described process, the present invention is used to automatically classify the transaction for tax and reporting purposes. The present invention allows authorized users access to the system to define and modify the rules used to classify transactions by the system 200 or method 500, 600. In operation, the system 200 or method 500, 600 may be utilized at different steps in the transaction process. For example, a user who has access to the system 200 during one of the initial steps of the transaction process, i.e., the quoting process, the credit process, the document preparation process, may provide an initial classification for the transaction. During the classification stage, the initial classification may be either accepted or denied based on the defined rules. If denied, the actual or true classification is determined by the rules. Alternatively, the transaction may be classified simply by the rules during the classification phase.

The classification of the transaction may be used for both tax determination and reporting requirements. The system 200 and method 500, 600 of the present invention may be part of a system used in the overall process above or a part of a separate system which is linked to other systems.

Other aspect and features of the present invention can be obtained from a study of the drawings, the disclosure, and the appended claims.

What is claimed is:

1. A computer based method for classifying a financial transaction for an item, including the steps of:
establishing a country associated with the financial transaction;
establishing a set of parameters associated with the financial transaction; and,
classifying the financial transaction as a function of the country, the set of parameters, and a set of predetermined rules.

2. A computer based method, as set forth in claim 1, wherein the set of parameters includes at least one of a term having an end and being associated with the transaction, an economic life of the item, a payment amount, a frequency of payment, a residual value guaranteed amount and a rate related to the transaction.

3. A computer based method, as set forth in claim 1, wherein the transaction is classified as one of a lease or a purchase.

4. A computer based method, as set forth in claim 1, wherein the transaction is classified as one of an operating lease, a true lease, a lease purchase, an installment sales contract, and a promissory note.

5. A computer based method, as set forth in claim 1, wherein the step of classifying the transaction includes the steps of:
determining if the transaction is an operating lease as a function of the country, the set of parameters, and the set of predetermined rules, and responsively classifying the transaction as an operating lease;
if the transaction is not an operating lease, determining if the transaction is a true lease as a function of the country, the set of parameters, and the set of predetermined rules, and responsively classifying the transaction as a true lease;
if the transaction is not a true lease, determining if the transaction is a lease purchase as a function of the country, the set of parameters, and the set of predetermined rules, and responsively classifying the transaction as a lease purchase;
if the transaction is not a lease purchase, determining if the transaction is an installment sales contract as a function of the country, the set of parameters, and the set of predetermined rules, and responsively classifying the transaction as an installment sales contract;
if the transaction is not an installment sales contract, determining if the transaction is a promissory note as a function of the country, the set of parameters, and the set of predetermined rules, and responsively classifying the transaction as a promissory note.

6. A computer based method, as set forth in claim 5, wherein the set of parameters includes an option value, a term having an end and being associated with the transaction, and a value associated with the item at the end of the term, wherein the step of determining if the transaction is an operating lease includes the step comparing the option value with the value associated with the item at the end of the term.

7. A computer based method, as set forth in claim 6, wherein the value associated with the item at the end of the term is a fair market value, wherein the transaction is not an operating lease if the option value is not equal to the fair market value.

8. A computer based method, as set forth in claim 6, wherein the value associated with the item at the end of the term is a value option (VO), wherein the transaction is not an operating lease if the option value is not equal to the VO.

9. A computer based method, as set forth in claim 6, wherein the value associated with the item at the end of the term is a residual value, wherein the transaction is not an operating lease if the option value is less than a predetermined percentage of the residual value.

10. A computer based method, as set forth in claim 5, wherein the set of parameters includes an economic life of the item and a term associated with the transaction, wherein the transaction is not an operating lease if the term is equal or greater than seventy-five percent of the economic life of the item.

11. A computer based method, as set forth in claim 5, wherein the set of parameters includes a net present value of minimum lease payments and a cost of the item, wherein the step of determining if the transaction is an operating lease includes the step of comparing the net present value of the minimum lease payment with the cost of the item.

12. A computer based method, as set forth in claim 11, wherein the transaction is not an operating lease if the net present value of the minimum lease payment is greater or equal to ninety percent (90%) of the cost of the item.

13. A computer based method, as set forth in claim 5, wherein the set of parameters includes a residual value and an original equipment cost, wherein the step of determining if the transaction is a true lease includes the step of comparing the residual value to the original equipment cost.

14. A computer based method, as set forth in claim 13, wherein the transaction is not a true lease if the residual value is less than a predetermined percentage of the original equipment cost.

15. A computer based method, as set forth in claim 5, wherein the set of parameters includes an option amount and a residual value, wherein the step of determining if the transaction is a lease purchase requirement includes the step of comparing the option amount and the residual value.

16. A computer based method, as set forth in claim 15, wherein the transaction is not a lease purchase requirement if the option amount is greater or equal to a fixed percentage of the residual value.

17. A computer based method, as set forth in claim 1, including the step of defining, by a user, the predetermined rules.

18. A computer based method, as set forth in claim 17, wherein the step of defining the predetermined rules, includes the steps of:
defining, by the user, the set of parameters; and,
defining, by the user, the set of rules as a function of the parameters.

19. A computer based method, as set forth in claim 18, wherein the set of rules includes at least one tax rule.

20. A computer based method, as set forth in claim 18, wherein the set of rules includes at least one accounting rule.

21. A computer based method, as set forth in claim 18, wherein the set of rules includes at least one tax rule and at least one accounting rule.

22. A computer based method for classifying a financial transaction for an item, including the steps of:
establishing a set of parameters associated with the transaction, the set of parameters including a term having an end and being associated with the transaction, an economic life of the item, a payment amount and a frequency of payment, a value associated with the item at the end of the term, and a rate related to the transaction; and,
classifying the transaction as a function of set of parameters.

23. A computer based method, as set forth in claim 22, wherein the transaction is classified as one of an operating lease, a true lease, a lease purchase, an installment sales contract, and a promissory note.

24. A computer based method, as set forth in claim 22, wherein the step of classifying the transaction includes the steps of:
determining if the transaction is an operating lease as a function of the set of parameters, and a set of predetermined rules, and responsively classifying the transaction as an operating lease;
if the transaction is not an operating lease, determining if the transaction is a true lease as a function of the set of parameters, and the set of predetermined rules, and responsively classifying the transaction as a true lease;
if the transaction is not a true lease, determining if the transaction is a lease purchase as a function of set of parameters, and the set of predetermined rules, and responsively classifying the transaction as a lease purchase; and,
if the transaction is not a lease purchase, determining if the transaction is an installment sales contract and responsively classifying the transaction as an installment sales contract; and,
if the transaction is not an installment sales contract, determining if the transaction is a promissory note and responsively classifying the transaction as a promissory note.

25. A computer based method, as set forth in claim 24, wherein the set of parameters includes an option value, wherein the step of determining if the transaction is an operating lease includes the step comparing the option value with the value associated with the item at the end of the term.

26. A computer based method, as set forth in claim 25, wherein the value associated with the item at the end of the term is a fair market value, wherein the transaction is not an operating lease if the option value is not equal to the fair market value.

27. A computer based method, as set forth in claim 25, wherein the value associated with the item at the end of the term is a value option (VO), wherein the transaction is not an operating lease if the option value is not equal to the VO.

28. A computer based method, as set forth in claim 25, wherein the value associated with the item at the end of the term is a residual value, wherein the transaction is not an operating lease if the option value is less than a predetermined percentage of the residual value.

29. A computer based method, as set forth in claim 24, wherein the transaction is not an operating lease if the term is equal or greater than seventy-five percent of the economic life of the item.

30. A computer based method, as set forth in claim 24, wherein the set of parameters includes a net present value of minimum lease payments and a cost of the item, wherein the step of determining if the transaction is an operating lease includes the step of comparing the net present value with the cost of the item.

31. A computer based method, as set forth in claim 30, wherein the transaction is not an operating lease if the net present value of the minimum lease payment is greater or equal to ninety percent (905) of the cost of the item.

32. A computer based method, as set forth in claim 24, wherein the set of parameters includes a residual value and an original equipment cost, wherein the step of determining if the transaction is a true lease includes the step of comparing the residual value to the original equipment cost.

33. A computer based method, as set forth in claim 32, wherein the transaction is not a true lease if the residual value is less than a predetermined percentage of the original equipment cost.

34. A computer based method, as set forth in claim 24, wherein the set of parameters includes an option amount and a residual value, wherein the step of determining if the transaction is a lease purchase requirement includes the step of comparing the option amount and the residual value.

35. A computer based method, as set forth in claim 34, wherein the transaction is not a lease purchase requirement if the option amount is greater or equal to a fixed percentage of the residual value.

36. A computer based method, as set forth in claim 22, including the step of defining, by a user, the predetermined rules.

37. A computer based method, as set forth in claim 36, wherein the step of defining the predetermined rules, includes the steps of:
defining, by the user, the set of parameters; and,
defining, by the user, the set of rules as a function of the parameters.

38. A computer based method, as set forth in claim 37, wherein the set of rules includes at least one tax rule.

39. A computer based method, as set forth in claim 37, wherein the set of rules includes at least one accounting rule.

40. A computer based method, as set forth in claim 37, wherein the set of rules includes at least one tax rule and at least one accounting rule.

41. A computer based system for classifying a transaction for an item, comprising:
a database for storing a set of predetermined rules;
a controller coupled to the database and being adapted to receive a country associated with the financial transaction and a set of parameters associated with the financial transaction and to classify the financial transaction as a function of the country, the set of parameters, and the set of predetermined rules.

42. A computer based system, as set forth in claim 41, wherein the set of parameters includes at least one of a term having an end and being associated with the transaction, an economic life of the item, a payment amount, a frequency of payment, a residual value guaranteed amount and a rate related to the transaction.

43. A computer based system, as set forth in claim 41, wherein the controller is adapted to classify the transaction as one of an operating lease, a true lease, a lease purchase, an installment sales contract, and a promissory note.

44. A computer based system, as set forth in claim 41, wherein the controller is adapted to determine if the transaction is an operating lease as a function of the country, the set of parameters, and the set of predetermined rules, and to responsively classify the transaction as an operating lease, if the transaction is not an operating lease, to determine if the transaction is a true lease as a function of the country, the set of parameters, and the set of predetermined rules, and responsively classify the transaction as a true lease, if the transaction is not a true lease, to determine if the transaction is a lease purchase as a function of the country, the set of parameters, and the set of predetermined rules, and responsively classify the transaction as a lease purchase, and, if the transaction is not a lease purchase, to determine if the transaction is an installment sales contract and to responsively classify the transaction as an installment sales contract, and, if the transaction is not an installment sales contract, to determine if the transaction is a promissory note and to responsively classify the transaction as a promissory note.

45. A computer based system, as set forth in claim 44, wherein the set of parameters includes an option value, a term associated with the transaction, and a value associated with the item at the end of the term and wherein the controller is adapted to compare the option value with the value associated with the item at the end of the term.

46. A computer based system, as set forth in claim 45, wherein the value associated with the item at the end of the term is a fair market value and wherein the transaction is not an operating lease if the option value is not equal to the fair market value.

47. A computer based system, as set forth in claim 45, wherein the value associated with the item at the end of the term is a value option (VO) and wherein the transaction is not an operating lease if the option value is not equal to the VO.

48. A computer based system, as set forth in claim 45, wherein the value associated with the item at the end of the term is a residual value and wherein the transaction is not an operating lease if the option value is less than a predetermined percentage of the residual value.

49. A computer based system, as set forth in claim 44, wherein the set of parameters includes an economic life of the item and a term associated with the transaction and wherein the transaction is not an operating lease if the term is equal or greater than seventy-five percent of the economic life of the item.

50. A computer based system, as set forth in claim 44, wherein the set of parameters includes a net present value of minimum lease payments and a cost of the item and wherein the controller is adapted to compare the net present value with the cost of the item.

51. A computer based system, as set forth in claim 50, wherein the transaction is not an operating lease if the net present value of the minimum lease payment is greater or equal to ninety percent (90%) of the cost of the item.

52. A computer based system, as set forth in claim 44, wherein the set of parameters includes a residual value and an original equipment cost and wherein the controller is adapted to compare the residual value to the original equipment cost.

53. A computer based system, as set forth in claim 52, wherein the transaction is not a true lease if the residual value is less than a predetermined percentage of the original equipment cost.

54. A computer based system, as set forth in claim 44, wherein the set of parameters includes an option amount and a residual value and wherein the controller is adapted to compare the option amount and the residual value.

55. A computer based system, as set forth in claim 54, wherein the transaction is not a lease purchase requirement if the option amount is greater or equal to a fixed percentage of the residual value.

56. A computer based system, as set forth in claim 41, wherein the controller is adapted to allow a user to define the predetermined rules.

57. A computer based system, as set forth in claim 56, wherein the controller is adapted to allow the user to the set of parameters, wherein the set of rules are defined as a function of the parameters.

58. A computer based system, as set forth in claim 57, wherein the set of rules includes at least one tax rule.

59. A computer based system, as set forth in claim 57, wherein the set of rules includes at least one accounting rule.

60. A computer based system, as set forth in claim 57, wherein the set of rules includes at least one tax rule and at least one accounting rule.

61. A computer based system for classifying a financial transaction for an item, comprising:
a database for storing a set of predetermined rules; and,
a controller coupled to the database and being adapted to receive a set of parameters associated with the transaction, the set of parameters including a term having an end and being associated with the transaction, an economic life of the item, a payment amount and a frequency of payment, a value associated with the item at the end of the term, and a rate related to the transaction and to classify the transaction as a function of the set of parameters.

62. A computer based system, as set forth in claim 61, wherein the transaction is classified as one of an operating lease, a true lease, a lease purchase, an installment sales contract, and a promissory note.

63. A computer based system, as set forth in claim 61, wherein the controller is adapted to determine if the transaction is an operating lease as a function of the set of parameters and the set of predetermined rules, and responsively classify the transaction as an operating lease, if the transaction is not an operating lease, to determine if the transaction is a true lease as a function of the set of parameters, and the set of predetermined rules and responsively classify the transaction as a true lease, if the transaction is not a true lease, to determine if the transaction is a lease purchase as a function of set of parameters, and the set of predetermined rules, and responsively classify the transaction as a lease purchase, and if the transaction is not a lease purchase, to determine if the transaction is an installment sales contract and responsively classify the transaction as an installment sales contract, if the transaction is not an installment sales contract, to determine if the transaction is a promissory note and responsively classify the transaction as a promissory note.

64. A computer based system, as set forth in claim 63, wherein the set of parameters includes an option value and the controller is adapted to compare the option value with the value associated with the item at the end of the term.

65. A computer based system, as set forth in claim 64, wherein the value associated with the item at the end of the term is a fair market value and wherein the transaction is not an operating lease if the option value is not equal to the fair market value.

66. A computer based system, as set forth in claim 64, wherein the value associated with the item at the end of the term is a value option (VO) and wherein the transaction is not an operating lease if the option value is not equal to the VO.

67. A computer based system, as set forth in claim 64, wherein the value associated with the item at the end of the term is a residual value and wherein the transaction is not an operating lease if the option value is less than a predetermined percentage of the residual value.

68. A computer based system, as set forth in claim 63, wherein the transaction is not an operating lease if the term is equal or greater than seventy-five percent of the economic life of the item.

69. A computer based system, as set forth in claim 63, wherein the set of parameters includes a net present value of minimum lease payments and a cost of the item and wherein the controller is adapted to compare the net present value with the cost of the item.

70. A computer based system, as set forth in claim 69, wherein the transaction is not an operating lease if the net present value of the minimum lease payment is greater or equal to ninety percent (90%) of the cost of the item.

71. A computer based system, as set forth in claim 63, wherein the set of parameters includes a residual value and an original equipment cost, wherein the step of determining if the transaction is a true lease includes the step of comparing the residual value to the original equipment cost.

72. A computer based system, as set forth in claim 71, wherein the transaction is not a true lease if the residual value is less than a predetermined percentage of the original equipment cost.

73. A computer based system, as set forth in claim 63, wherein the set of parameters includes an option amount and a residual value and wherein the controller is adapted to compare the option amount and the residual value.

74. A computer based system, as set forth in claim 73, wherein the transaction is not a lease purchase requirement if the option amount is greater or equal to a fixed percentage of the residual value.

75. A computer based system, as set forth in claim 60, wherein the controller is adapted to allow a user to define the predetermined rules.

76. A computer based system, as set forth in claim 75, wherein the controller is adapted to allow the user to the set of parameters, wherein the set of rules are defined as a function of the parameters.

77. A computer based system, as set forth in claim 76, wherein the set of rules includes at least one tax rule.

78. A computer based system, as set forth in claim 76, wherein the set of rules includes at least one accounting rule.

79. A computer program product for classifying a financial transaction for an item, comprising:
computer readable program code means for establishing a country associated with the financial transaction;
computer readable program code means for establishing a set of parameters associated with the financial transaction; and,
computer readable program code means for classifying the financial transaction as a function of the country, the set of parameters, and a set of predetermined rules.

80. A computer program product for classifying a financial transaction for an item, comprising:
computer readable program code means for establishing a set of parameters associated with the transaction, the set of parameters including a term having an end and being associated with the transaction, an economic life of the item, a payment amount and a frequency of payment, a value associated with the item at the end of the term, and a rate related to the transaction; and,
computer readable program code means for classifying the transaction as a function of set of parameters.
